(19) United States
(12) Patent Application Publication
(10) Pub. No.: US 2026/0184075 A1
(43) Pub. Date: Jul. 2, 2026

(54) LIQUID EJECTION HEAD AND INKJET HEAD

(71) Applicant: RISO Technologies Corporation, Tokyo (JP)

(72) Inventor: Masato FUKASAWA, Mishima Shizuoka (JP)

(21) Appl. No.: 19/286,129

(22) Filed: Jul. 30, 2025

(30) Foreign Application Priority Data
Dec. 27, 2024 (JP) 2024-231913
Apr. 25, 2025 (JP) 2025-073698

(51) Int. Cl. B41J 2/14; B41J 2/165

(52) U.S. Cl. CPC B41J 2/1433; B41J 2/14233; B41J 2/16507; B41J 2002/14306

(57) ABSTRACT

A liquid ejection head includes a nozzle plate that includes a plurality of nozzles through which liquid is ejected in a first direction, the nozzle plate having a first surface that faces the first direction and a second surface opposite to the first surface, a nozzle cover that faces the first surface of the nozzle plate and has openings at locations corresponding to the nozzles, and a flow path member that contacts the second surface of the nozzle plate and forms one or more flow paths of the liquid that communicate with the nozzles. The nozzle plate is flexible and includes: a damper portion that extends across one of the flow paths, and a bonding portion that is bonded to the flow path member. The nozzle cover is bonded to the nozzle plate at a location other than the damper portion of the nozzle plate.

### CROSS-REFERENCE TO RELATED APPLICATION

This application is based upon and claims the benefit of priority from Japanese Patent Application No. 2024-231913, filed on Dec. 27, 2024, and No. 2025-073698, filed on Apr. 25, 2025, the entire contents of which are incorporated herein by reference.

### FIELD

Embodiments described herein relate generally to a liquid ejection head and an inkjet head.

### BACKGROUND

In a liquid ejection head such as an inkjet head, a nozzle cover may be formed on the ejection side surface of the nozzle plate for protection. Additionally, the nozzle plate may be made from a flexible film material such as polyimide or PI to serve as a damper for suppressing the water hammer phenomenon.

### BRIEF DESCRIPTION OF THE DRAWINGS

FIG. 1 is a perspective view showing a configuration of a liquid ejection head according to an embodiment.

FIG. 2 is a perspective view showing a configuration of the liquid ejection head.

FIG. 3 is a bottom view showing a configuration of a part of the liquid ejection head.

FIG. 4 is a cross-sectional view showing a configuration of a part of the liquid ejection head.

FIG. 5 is a cross-sectional view schematically showing a configuration of a part of the liquid ejection head.

FIG. 6 is a view showing a configuration of an adhesive layer.

### DETAILED DESCRIPTION

In general, according to one embodiment, a liquid ejection head and an inkjet head capable of suppressing a water hammer phenomenon and protecting a nozzle plate is provided.

In one embodiment, a liquid ejection head comprises: a nozzle plate that includes a plurality of nozzles through which liquid is ejected in a first direction, the nozzle plate having a first surface that faces the first direction and a second surface opposite to the first surface; a nozzle cover that faces the first surface of the nozzle plate and has openings at locations corresponding to the nozzles; and a flow path member that contacts the second surface of the nozzle plate and forms one or more flow paths of the liquid that communicate with the nozzles. The nozzle plate is flexible and includes: a damper portion that extends across one of the flow paths, and a bonding portion that is bonded to the flow path member. The nozzle cover is bonded to the nozzle plate at a location other than the damper portion of the nozzle plate.

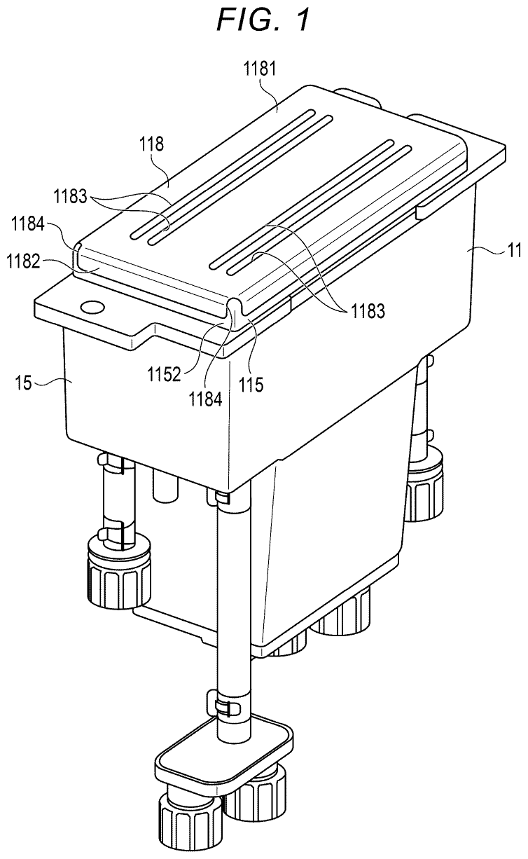

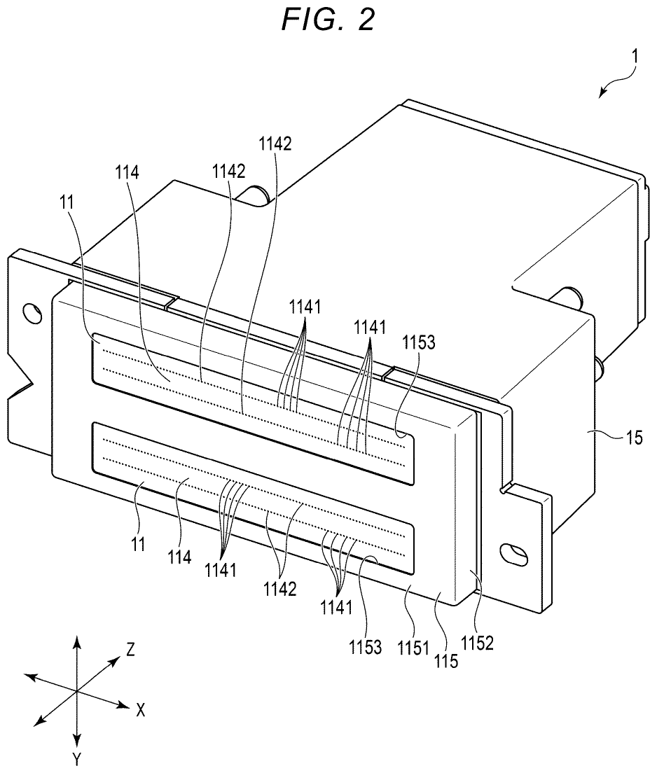

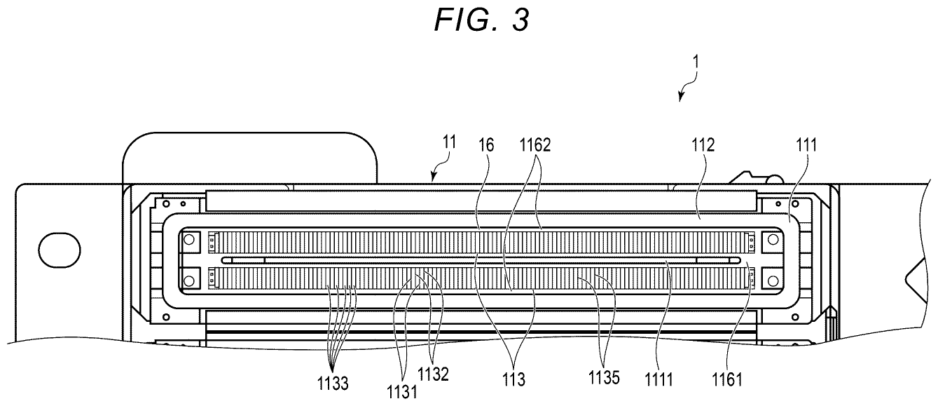

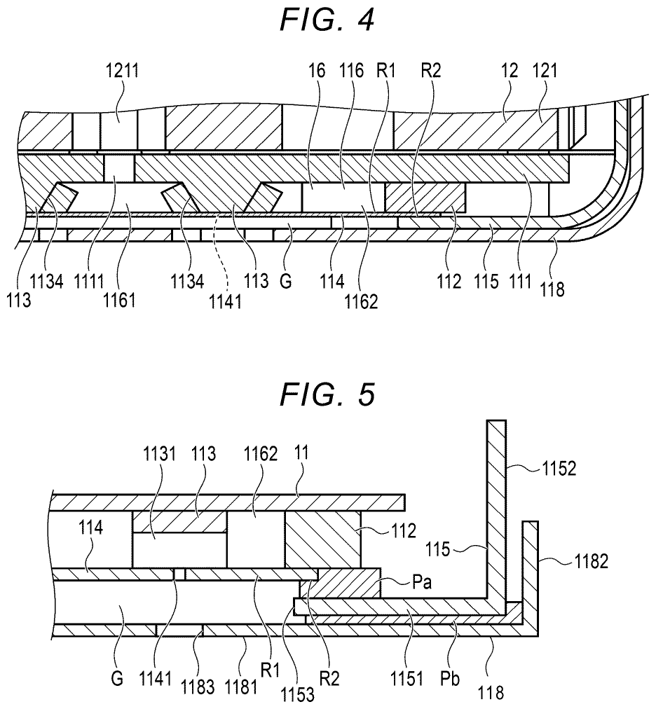

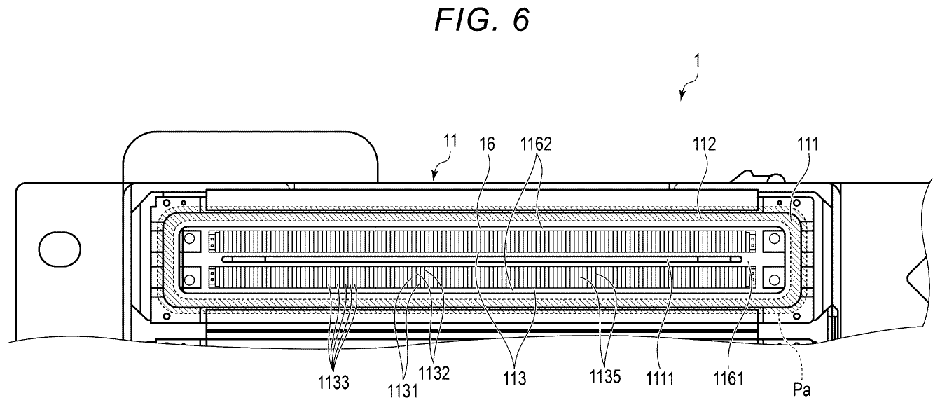

Hereinafter, a liquid ejection head 1 according to an embodiment will be described with reference to FIGS. 1 to 5. FIGS. 1 and 2 are perspective views showing a configuration of the liquid ejection head 1 according to the present embodiment. FIG. 3 is a bottom view showing an internal configuration of the liquid ejection head 1, and FIG. 4 is a cross-sectional view showing a configuration of a part of the liquid ejection head 1. FIG. 5 is a cross-sectional view schematically showing a configuration of a part of the liquid ejection head 1. FIG. 6 is a view showing a configuration of an adhesive layer of the liquid ejection head 1. In the drawings, X, Y, and Z indicate a first direction, a second direction, and a third direction orthogonal to one another. In the drawings, a configuration is shown enlarged, reduced, or omitted as appropriate for the purpose of description.

The liquid ejection head 1 is, for example, a shear mode inkjet head provided in a liquid ejection device such as an inkjet recording device. The liquid ejection head 1 has, for example, an independent drive structure in which pressure chambers 1131 and air chambers 1132 are alternately provided.

The liquid ejection head 1 stores and ejects liquid such as ink. The liquid ejection head 1 may be a non-circulation type head that does not circulate ink, or may be a circulation type head that circulates ink. In the present embodiment, the liquid ejection head 1 will be described using an example of the non-circulation type head.

As shown in FIGS. 1 to 5, the liquid ejection head 1 includes a head main body 11, a manifold unit 12, and a cover 15. For example, the liquid ejection head 1 is a four-row integral structure head of a side shooter type including two sets of the head main bodies 11 each including a pair of actuators 113.

The head main body 11 ejects liquid. The head main body 11 includes a substrate 111, a frame body 112 serving as a flow path member, the actuators 113 having a plurality of the pressure chambers 1131 and a plurality of the air chambers 1132, a nozzle plate 114, an exterior cover 115, and a nozzle cover 118. A predetermined ink flow path 16 passing through the pressure chambers 1131 communicating with nozzles 1141 is formed inside the head main body 11. The ink flow path 16 is a liquid flow path.

The head main body 11 includes, as a part of the ink flow path 16, a common flow path portion 116 communicating with the plurality of pressure chambers 1131 of the actuator 113. The primary side of the plurality of pressure chambers 1131 correspond to the upstream side of the plurality of pressure chambers 1131 in the liquid flowing direction. The secondary side of the plurality of pressure chambers 1131 corresponds to the downstream side of the plurality of pressure chambers 1131 in the liquid flowing direction.

The head main body 11 includes an electrode portion formed of an electrode film formed on the substrate 111 and the actuator 113. Specifically, the head main body 11 includes, as the electrode portion, a plurality of individual electrodes that respectively drive the plurality of pressure chambers 1131 of the actuator 113, and one or a plurality of common electrodes that drive the plurality of pressure chambers 1131 at the same time.

In the present embodiment, the head main body 11 includes two actuators 113, and the common flow path portion 116 includes one first common flow path 1161 and two second common flow paths 1162. The common flow path portion 116 includes, for example, the first common flow path 1161 that communicates with openings on one side (i.e., inlets of the pressure chambers 1131) of the plurality of pressure chambers 1131 of the actuator 113, and the second common flow paths 1162 that communicate with openings (i.e., outlets of the pressure chambers 1131) on a secondary side of the plurality of pressure chambers 1131 of the actuator 113.

That is, the first common flow path 1161 is disposed on one end side in the second direction (i.e., Y direction) of a plurality of actuator grooves 1135 each extending in the second direction, and the second common flow paths 1162 are disposed on the other end side of the actuator grooves 1135 of the pair of actuators 113. The first common flow path 1161 and the second common flow path 1162 communicate with each other at both ends in the first direction.

The substrate 111 is formed in a rectangular plate shape, and is formed of ceramics such as alumina. For example, the substrate 111 is formed in a rectangular shape elongated in one direction (i.e., X direction). An electrode film is formed on a surface on one side of the substrate 111. The pair of actuators 113 are provided on a front surface of the substrate 111 and are arranged in a transverse direction (i.e., Y direction) of the substrate 111. The substrate 111 has a single supply port 1111 which is an opening through which a liquid passes. The supply port 1111 is a through hole that passes between two main surfaces of the substrate 111.

The back surface of the substrate 111 faces a manifold 121 and covers a groove that is formed on the facing surface of the manifold 121 and forms a cooling flow path through which cooling water flows. That is, the substrate 111 forms a cooling flow path together with the manifold 121.

The supply port 1111 is an inlet for supplying ink to the first common flow path 1161. The supply port 1111 is a through hole formed in a center of the substrate 111 in the transverse direction. The supply port 1111 extends along a longitudinal direction of the substrate 111. In other words, the supply port 1111 is, for example, an elongated hole that is long in one direction along the longitudinal direction of the actuator 113 and the longitudinal direction of the first common flow path 1161. The supply port 1111 is provided between the pair of actuators 113 and opens at a position facing the first common flow path 1161. A part of the common electrode may be formed on an inner wall surface of the supply port 1111.

The actuator 113 and the frame body 112 are provided on the substrate 111. The inside of the frame body 112 on the substrate 111 is a liquid contact region where ink is stored, and the outer side of the frame body 112 is a mounting region where various electronic components can be connected. The frame body 112 is a flow path member for forming a liquid flow path including the pressure chambers 1131 and the common flow path 1161.

The frame body 112 is fixed to one main surface of the substrate 111 by an adhesive or the like. The frame body 112 surrounds the actuator 113 and the supply port 1111 provided in the substrate 111.

For example, the frame body 112 is formed in a rectangular frame shape, and thus an opening that is long along the longitudinal direction of the frame body 112 is formed. The pair of actuators 113 and the supply port 1111 are disposed in the opening of the frame body 112. The frame body 112 surrounds the periphery of the actuators 113 between the nozzle plate 114 and the substrate 111, and can hold a liquid inside the frame body 112. That is, a predetermined ink flow path including the pressure chambers 1131 and the common flow paths 1161 and 1162 is formed in the head main body 11 by the frame body 112, the nozzle plate 114, the substrate 111, and the actuators 113.

The pair of actuators 113 are bonded to a surface of the substrate 111. The pair of actuators 113 are provided on the substrate 111 in two rows with the supply port 1111 interposed therebetween. The actuator 113 is a plate-shaped member elongated in one direction. The actuators 113 are disposed in the opening of the frame body 112 and bonded to the surface of the substrate 111.

At the center in the longitudinal direction, the actuator 113 includes the plurality of pressure chambers 1131 disposed at equal intervals in the longitudinal direction, and the plurality of air chambers 1132 that are disposed at equal intervals in the longitudinal direction and each of which is disposed between the adjacent pressure chambers 1131. In other words, in the actuator 113, the plurality of pressure chambers 1131 and the plurality of air chambers 1132 are alternately disposed along the longitudinal direction. The plurality of pressure chambers 1131 and the plurality of air chambers 1132 extend in a direction intersecting an arrangement direction, for example, in a transverse direction of the actuator 113.

A top surface portion which is a surface of the actuator 113 opposite to the substrate 111 is bonded to the nozzle plate 114. The actuator 113 has a plurality of actuator grooves 1135 which are disposed at equal intervals in the longitudinal direction and extend in a direction orthogonal to the longitudinal direction. The plurality of actuator grooves 1135 form the plurality of pressure chambers 1131 and the plurality of air chambers 1132. In other words, the actuator 113 includes a plurality of piezoelectric bodies 1133 that are disposed at equal intervals in the longitudinal direction and are drive elements for constituting walls defining the actuator grooves 1135 therebetween. The plurality of piezoelectric bodies 1133 form the plurality of pressure chambers 1131 and the plurality of air chambers 1132 between adjacent piezoelectric bodies 1133, and change volumes of the pressure chambers 1131 by applying a drive voltage.

For example, a width of the actuator 113 in the transverse direction gradually increases from the top side toward the substrate 111. A cross-sectional shape of the actuator 113 along the transverse direction orthogonal to the longitudinal direction is formed to be trapezoidal. That is, the actuator 113 has an inclined surface 1134 inclined to a side surface portion in the transverse direction. The side surface portion (inclined surface 1134) is disposed to face the first common flow path 1161 and the second common flow path 1162. An electrode film is formed in a predetermined pattern on the inclined surface 1134.

For example, the actuator 113 is formed of a stacked piezoelectric member in which two piezoelectric materials each having a rectangular plate shape elongated in one direction are bonded to each other such that polarization directions thereof are opposite to each other. Here, the piezoelectric material is, for example, lead zirconate titanate (PZT). The actuator 113 is bonded to a surface of the substrate 111 by, for example, an adhesive. The actuator 113 has the inclined surface 1134. The actuator 113 has the plurality of actuator grooves 1135 for forming the plurality of pressure chambers 1131 and the plurality of air chambers 1132, and has the piezoelectric bodies (i.e., the drive elements) 1133 which are side walls partitioning the adjacent actuator grooves 1135.

In the actuator 113, an electrode film constituting an individual electrode or a common electrode is formed in a predetermined pattern.

The pressure chamber 1131 is deformed when the liquid ejection head 1 performs an operation such as printing, thereby ejecting ink from the nozzles 1141. The pressure chamber 1131 has an inlet that is open to the first common flow path 1161 and an outlet that is open to the second common flow path 1162. The ink flows into the pressure chamber 1131 from the inlet and flows out from the outlet. The pressure chamber 1131 may have a configuration in which the ink flows in from both openings described as the inlet and the outlet. An individual electrode is formed in each actuator groove 1135 constituting the pressure chamber 1131.

The inlet side and the outlet side of the pressure chamber 1131 may be partially closed by a liquid prevention wall formed of a photosensitive resin or the like. For example, a part of opening portions of the groove of the pressure chamber 1131 at both end portions in the extending direction of the groove is closed by a liquid prevention wall, so that, for example, a throttle flow path is formed at the inlet and the outlet of the pressure chamber 1131 communicating with the first common flow path 1161 and the second common flow path 1162, in which the groove width is narrower and a flow path cross section is smaller than those of the inner side of the pressure chamber 1131.

The air chamber 1132 is separated from the first common flow path 1161 and the second common flow path 1162 by blocking the inlet side and the outlet side with a liquid prevention wall formed of a photosensitive resin or the like. The air chamber 1132 is closed by the nozzle plate 114 and no nozzle 1141 is disposed. Therefore, no ink flows into the air chamber 1132.

The nozzle plate 114 is formed in a plate shape. The nozzle plate 114 is formed of a flexible film such as a polyimide film. The nozzle plate 114 has, for example, a Young's modulus of 9.1 GPa or more. The nozzle plate 114 is disposed to face one side of the actuator 113 in a third direction (i.e., Z direction). For example, the nozzle plate 114 functions as a pressure buffer damper for suppressing a water hammer phenomenon occurring in the common flow path. The nozzle plate 114 is fixed to the surface of the frame body 112 at the side opposite to the substrate 111 by an adhesive or the like. The nozzle plate 114 includes a plurality of nozzles 1141 formed at positions facing the plurality of pressure chambers 1131. In the present embodiment, the nozzle plate 114 has two nozzle rows 1142 in which the plurality of nozzles 1141 are aligned in one direction. A water repellent film is formed on an ink ejection surface side of the nozzle plate 114.

The exterior cover 115 is formed by bending a plate member made of a metal material such as a SUS material. The exterior cover 115 integrally includes a rectangular flat plate-shaped top plate portion 1151 (hereinafter also referred to as a top portion) that covers a predetermined region of the ejection surface of the nozzle plate 114, and a peripheral wall portion 1152 that is curved from an outer peripheral edge of the top plate portion 1151 and extends in the Z direction.

The top plate portion 1151 is a flat plate-shaped member disposed to face a predetermined region of a discharge side surface of the substrate 111, the predetermined region being formed in a manner of avoiding a portion where the nozzle 1141 is formed. For example, the top plate portion 1151 is formed in a rectangular shape having an outer shape larger than that of the substrate 111, and has two opening portions 1153 formed at portions corresponding to the two rows of actuators 113. The top plate portion 1151 is bonded to the frame body 112 via, for example, an adhesive layer Pa. The top plate portion 1151 is bonded to the nozzle plate 114 at a position avoiding a damper portion R1 disposed to face a discharge side of the common flow path.

For example, the top plate portion 1151 is bonded to the nozzle plate 114 and the frame body 112 over the entire periphery of the frame body 112 surrounding an outer periphery of each actuator 113. As shown in FIGS. 5 and 6, the adhesive layer Pa that bonds the frame body 112, the nozzle plate 114, and the top plate portion 1151 is disposed outside an inner edge of the frame body 112. Further, the adhesive layer Pa may be disposed to reach an outer peripheral side of the frame body 112.

For example, as shown in FIG. 5, an adhesive region of the adhesive layer Pa is set outside the opening portion 1153 of the top plate portion 1151.

For example, in the present embodiment, the two opening portions 1153 of the top plate portion 1151 respectively correspond to the two rows of actuators 113, and are formed in a rectangular shape whose longitudinal direction is along the X direction. The peripheral wall portion 1152 is a vertical wall portion bent from an outer peripheral edge of the top plate portion 1151 and extending in the Z direction. The peripheral wall portion 1152 covers outer peripheral portions of the frame body 112 and the manifold 121.

The nozzle cover 118 integrally includes a top cover portion 1181 (hereinafter also referred to as a cover portion) facing the ejection surface side of the nozzle plate 114 or the top plate portion 1151, and an edge cover portion 1182 curved from an outer peripheral edge of the top cover portion 1181 and extending in the Z direction. The top cover portion 1181 is a flat plate-shaped portion having a rectangular outer shape larger than that of the substrate 111. The top cover portion 1181 has a plurality of cover openings 1183 respectively facing positions on one side of the plurality of nozzles 1141. For example, the cover opening 1183 is a long hole extending in one direction which is the longitudinal direction of the substrate 111 and extends in the one direction. The cover opening 1183 has an opening area smaller than that of the opening portion 1153 of the exterior cover 115. For example, four cover openings 1183 are formed respectively corresponding to four rows of the nozzles 1141, and each cover opening 1183 is a through-hole having a width in the Y direction larger than a diameter of the nozzle 1141 and smaller than a width of the opening portion 1153 of the exterior cover 115.

The edge cover portion 1182 is disposed to overlap an outer surface of the peripheral wall portion 1152 of the exterior cover 115 and covers an outer peripheral portion of the exterior cover 115. The nozzle cover 118 is bonded to the outer surface of the exterior cover 115 via, for example, an adhesive layer Pb. In the present embodiment, cut-out portions 1184 cut in a slit shape are formed at positions of the edge cover portion 1182 corresponding to four corners of the peripheral wall portion 1152 of the exterior cover 115. The edge cover portion 1182 is divided, by the cut-out portions 1184, into four plate-shaped pieces facing outer sides of four outer surfaces of the peripheral wall portion 1152.

The nozzle cover 118 is directly or indirectly supported at a position where deformation of the damper portion R1, which is a portion where the nozzle plate 114 functions as a damper, is not hindered. For example, the nozzle cover 118 is bonded, via the adhesive layer Pb, to the ejection surface side of the top plate portion 1151, which is bonded to the ejection surface side of a peripheral edge of the nozzle plate 114 via the adhesive layer Pa.

The nozzle cover 118 and the exterior cover 115 are bonded by the adhesive layer Pb, for example, on the entire surface of the top plate portion 1151 on a discharge side.

For example, the top plate portion 1151 is bonded to the nozzle cover 118 at a position corresponding to the entire periphery of the frame body 112 surrounding an outer periphery of each actuator 113. For example, as shown in FIG. 5, an adhesive region of the adhesive layer Pb is set outside the opening portion 1153 of the top plate portion 1151.

Therefore, the nozzle cover 118 is spaced apart from the nozzle plate 114 by a predetermined distance on the discharge side and is disposed to face the nozzle plate 114 with a gap G therebetween. The nozzle cover 118 faces at least a part of a liquid flow path in the nozzle plate 114, for example, the second common flow path 1162, and is bonded and supported at a position avoiding the damper portion R1 that functions as a damper.

The first common flow path 1161 is formed between central sides of the pair of actuators 113 excluding both end portions, and constitutes a flow path for ink from the supply port 1111 to openings (i.e., inlets) on the primary side of the plurality of pressure chambers 1131 of each actuator 113. The first common flow path 1161 extends along the longitudinal direction of the actuator 113. The first common flow path 1161 constitutes a part of the ink flow path 16.

The second common flow path 1162 is formed between each actuator 113 and the frame body 112. The second common flow path 1162 forms a flow path for ink from openings (i.e., outlets) on the secondary side of the plurality of pressure chambers 1131. The second common flow path 1162 extends along the longitudinal direction of the actuator 113. The second common flow path 1162 constitutes a part of the ink flow path 16.

In the liquid ejection head 1, the liquid flows into the supply port 1111, flows from the first common flow path 1161 at the center to outer sides of both ends in the first direction of the actuator 113, and flows into the second common flow path 1162. That is, the ink supplied from the supply port 1111 passes through the first common flow path 1161 which is a central flow path closer to the supply port 1111 and the second common flow path 1162 which is a side flow path farther from the supply port 1111, and is supplied to the actuator groove 1135 for forming the pressure chamber 1131 from both sides of the actuator groove 1135 in the Y direction which is the extending direction of the actuator groove 1135.

The plurality of individual electrodes individually apply a drive voltage to the plurality of piezoelectric bodies 1133 which are drive elements. The plurality of individual electrodes individually deform the respective pressure chambers 1131. The individual electrode is formed with a wiring pattern formed on the substrate 111 and a wiring pattern formed on the actuator 113.

The common electrode applies the same drive voltage to all of the plurality of piezoelectric bodies 1133. The common electrode deforms the plurality of pressure chambers 1131 at the same time. The common electrode is formed with a wiring pattern formed on the substrate 111 and a wiring pattern formed on the actuator 113.

The individual electrode or the common electrode of the actuator 113 is disposed in the cover 15 and is connected to a circuit board on which a driver IC is mounted. For example, the circuit board drives the actuator 113 by applying a drive voltage to the wiring pattern of the actuator 113 by the driver IC, increases or decreases the volume of the pressure chamber 1131, and discharges a droplet from the nozzle 1141.

The manifold unit 12 includes the manifold 121 and an ink supply pipe. The manifold unit 12 may further include a cooling water supply pipe and a cooling water discharge pipe.

The manifold 121 is formed in a plate shape or a block shape. The manifold 121 is formed, for example, by integrally assembling a plurality of members, and forms a supply path 1211 and a cooling flow path.

For example, the manifold 121 includes the supply path 1211 that is continuous with the supply port 1111 of the substrate 111 and forms a liquid supply flow path, and the cooling flow path that forms a flow path of cooling fluid. Since the manifold 121 is connected to the pair of head main bodies 11, the manifold 121 includes a pair of supply paths 1211.

One surface of the manifold 121 is fixed to a surface of the substrate 111. A top plate is provided on the surface of the manifold 121 opposite to the surface to which the substrate 111 is fixed. An ink supply pipe is fixed to the manifold 121 via the top plate.

The supply path 1211 fluidly connects the ink supply pipe and the supply port 1111 of the substrate 111. The supply path 1211 is a liquid flow path between the ink supply pipe and the supply port 1111.

The ink supply pipe is connected to the supply path 1211. In the present embodiment, since the liquid ejection head 1 includes a pair of the head main bodies 11, a pair of ink supply pipes is provided.

The cover 15 covers, for example, side surfaces of the pair of head main bodies 11 and the manifold unit 12.

The liquid ejection head 1 configured as described above includes, in the head main bodies 11, a plurality of individual electrodes capable of individually applying a drive voltage to each of the piezoelectric bodies 1133, and a common electrode capable of applying a drive voltage to all the piezoelectric bodies 1133.

Therefore, the liquid ejection head 1 can selectively, individually, or commonly drive the plurality of pressure chambers 1131. When the pressure chambers 1131 are driven, the pressure chambers 1131 are deformed in a shear mode, and ink supplied into the pressure chambers 1131 is pressurized. Therefore, the liquid ejection head 1 can selectively eject the pressurized ink from the nozzles 1141 facing the pressure chambers 1131.

In the present embodiment, the substrate 111 and the frame body 112 are disposed as flow path members constituting a flow path for supplying ink on an opposite side of the nozzle plate 114 to an ink ejection side, and the common flow paths 1161 and 1162 are formed as an ink flow path extending in a row direction of the nozzles 1141 by these flow path members. The nozzle plate 114 is formed of a flexible material such as polyimide, and is used as a pressure buffer damper for suppressing water hammer generated in an ink flow path extending in the row direction. In the liquid ejection head 1 according to the present embodiment, an electrode for driving the actuator 113 configured to eject ink is formed in the ink flow path, and the exterior cover 115 for protecting the electrode is bonded to an ink ejection surface of the nozzle plate 114 at a portion other than the damper portion R1 serving as the pressure buffer damper. The exterior cover 115 covers an ink ejection surface side and a side surface of the ink flow path. Further, the nozzle plate 114 is bonded at a portion other than the damper portion R1 serving as the pressure buffer damper. That is, the nozzle plate 114 has the damper portion R1 facing the common flow path and a bonding portion R2 set at a position different from the damper portion R1.

The nozzle cover 118 having a shape that covers the ink ejection surface side and a part of the side surface of the exterior cover 115 is bonded to the exterior cover 115, and the cover opening 1183 of the nozzle cover 118 has an opening area narrower than that of the opening portion 1153 of the exterior cover 115. For example, a width dimension of the cover opening 1183 in the Y direction which is an extending direction is narrower than a width dimension of the opening portion 1153 in the Y direction.

According to the liquid ejection head 1 configured as described above, by providing the gap G between the nozzle plate 114 and the nozzle cover 118 that protects the nozzle 1141, the nozzle plate 114 can be protected without hindering the movement of the nozzle plate 114. That is, when the nozzle plate 114 formed with the nozzles 1141 is used as a pressure buffer damper, since the movement of the damper portion R1 which is a region facing the common flow path in the nozzle plate 114 is not hindered and deformation can be allowed, the function as the pressure buffer damper can be maintained, and an influence of a water hammer can be reduced.

Embodiments of this disclosure are not limited to the above-described configuration. For example, although a side shooter type inkjet head is exemplified in the above embodiment, the disclosure is not limited thereto, and an end shooter type inkjet head may be used. Although the liquid ejection head 1 is of an independent drive type in which the pressure chambers and the air chambers are alternately formed, the disclosure is not limited thereto.

For example, although the common flow paths on both sides of the pressure chamber 1131 are supply sides, and ink flows in from both sides, the disclosure is not limited thereto. For example, an inkjet head may be used, in which one side of the pressure chamber 1131 is a supply side, the other side is a discharge side, and ink flows in from the one side of the pressure chamber 1131 and flows out from the other side. Further, the supply side and the discharge side may be reversed, or may be configured to be switchable.

Although the liquid ejection head 1 is of a non-circulation type in the example described above, the liquid ejection head 1 may be of a circulation type. For example, as a configuration in which a flow path is also formed on a discharge side, there may be a configuration in which discharge ports are formed at, for example, both end portions of the substrate 111 in the first direction, a liquid discharge path continuous with the discharge port of the substrate 111 is formed in the manifold 121, and a collection flow path connected to the liquid discharge path is provided.

For example, although an example is described above in which a cross section of the actuator 113 is trapezoidal and a cross section of the second common flow path 1162 is also trapezoidal with one side inclined, the disclosure is not limited thereto. For example, the cross section may be a rectangular shape or other cross-sectional shapes.

For example, a liquid to be ejected is not limited to ink for printing, and for example, the disclosure may be applied to a device that ejects a liquid containing conductive particles for forming a wiring pattern of a printed wiring board.

Although the inkjet head is used in a liquid ejection device such as the inkjet printer described above, the disclosure is not limited thereto. For example, the inkjet head may be used in a 3D printer, an industrial manufacturing machine, and a medical application, and the inkjet head can be reduced in size, weight, and cost.

According to at least one embodiment described above, it is possible to protect the nozzle while ensuring a water hammer suppression function by the nozzle plate.

While certain embodiments have been described, these embodiments have been presented by way of example only and are not intended to limit the scope of the disclosure. These novel embodiments can be implemented in various other forms, and various omissions, substitutions, and modifications can be made without departing from the gist of the disclosure. The embodiments and the modifications thereof are included in the scope and the gist of the disclosure, and are included in the scope of the disclosure disclosed in the claims and equivalents thereof.

What is claimed is:

1. A liquid ejection head comprising:
a nozzle plate that includes a plurality of nozzles through which liquid is ejected in a first direction, the nozzle plate having a first surface that faces the first direction and a second surface opposite to the first surface;
a nozzle cover that faces the first surface of the nozzle plate and has openings at locations corresponding to the nozzles; and
a flow path member that contacts the second surface of the nozzle plate and forms one or more flow paths of the liquid that communicate with the nozzles, wherein
the nozzle plate is flexible and includes:
a damper portion that extends across one of the flow paths, and
a bonding portion that is bonded to the flow path member, and
the nozzle cover is bonded to the nozzle plate at a location other than the damper portion of the nozzle plate.

2. The liquid ejection head according to claim 1, further comprising:
an exterior cover including a first portion that is bonded to both the nozzle plate and the nozzle cover.

3. The liquid ejection head according to claim 2, wherein
the exterior cover has an opening that is between the nozzle plate and the nozzle cover and is greater than each of the openings of the nozzle cover.

4. The liquid ejection head according to claim 2, wherein
the nozzle cover and the exterior cover respectively have peripheral walls that face each other in a second direction perpendicular to the first direction.

5. The liquid ejection head according to claim 1, wherein
the flow path member forms a plurality of pressure chambers, each of which is capable of storing the liquid and communicates with a corresponding one of the nozzles, a volume of each of the pressure chambers being varied to eject the liquid from the corresponding nozzle.

6. The liquid ejection head according to claim 5, wherein
said one of the flow paths is a common flow path that communicates with the pressure chambers.

7. The liquid ejection head according to claim 1, wherein
the damper portion of the nozzle plate is spaced apart from the nozzle cover.

8. The liquid ejection head according to claim 1, further comprising:
a body to which the flow path member is fixed, wherein
said one of the flow paths extends along the body, the flow path member, and the damper portion of the nozzle plate.

9. The liquid ejection head according to claim 8, further comprising:
a plurality of pressure chambers between the body and the nozzles, each of the pressure chambers being capable of storing the liquid and communicating with a corresponding one of the nozzles.

10. The liquid ejection head according to claim 1, wherein
a first set of the nozzles is arranged in two rows extending in a second direction perpendicular to the first direction.

11. The liquid ejection head according to claim 10, further comprising:
an exterior cover bonded to both the nozzle plate and the nozzle cover and having an opening through which the first set of nozzles ejects the liquid.

12. The liquid ejection head according to claim 10, wherein
the liquid ejection head is of a side shooter type.

13. The liquid ejection head according to claim 1, wherein
the bonding portion is bonded to the nozzle cover.

14. An inkjet head comprising:
a nozzle plate that includes a plurality of nozzles through which ink is ejected in a first direction, the nozzle plate having a first surface that faces the first direction and a second surface opposite to the first surface;
a nozzle cover that faces the first surface of the nozzle plate and has openings at locations corresponding to the nozzles; and
a frame that contacts the second surface of the nozzle plate and forms one or more flow paths of the ink that communicate with the nozzles, wherein
the nozzle plate is flexible and includes:
a damper portion that extends across one of the flow paths, and
a bonding portion that is bonded to the frame, and
the nozzle cover is bonded to the nozzle plate at a location other than the damper portion of the nozzle plate.

15. The inkjet head according to claim 14, wherein
the inkjet head is a shear mode inkjet head.

16. The inkjet head according to claim 14, further comprising:
an exterior cover including a first portion that is bonded to both the nozzle plate and the nozzle cover.

17. The inkjet head according to claim 16, wherein
the exterior cover has an opening that is between the nozzle plate and the nozzle cover and is greater than each of the openings of the nozzle cover.

18. The inkjet head according to claim 16, wherein
the nozzle cover and the exterior cover respectively have peripheral walls that face each other in a second direction perpendicular to the first direction.

19. The inkjet head according to claim 14, wherein
the frame forms a plurality of pressure chambers, each of which is capable of storing the ink and communicates with a corresponding one of the nozzles, a volume of each of the pressure chambers being varied to eject the ink from the corresponding nozzle.

20. The inkjet head according to claim 19, wherein
said one of the flow paths is a common flow path that communicates with the pressure chambers.
